(19) United States
(12) Patent Application Publication
(10) Pub. No.: US 2025/0286957 A1
(43) Pub. Date: Sep. 11, 2025

(54) QUALITY INSPECTION APPARATUS AND INSPECTION SYSTEM

(71) Applicant: CANON KABUSHIKI KAISHA, Tokyo (JP)

(72) Inventor: YUKICHIKA ICHIHASHI, Chiba (JP)

(21) Appl. No.: 19/216,342

(22) Filed: May 22, 2025

Related U.S. Application Data
(63) Continuation of application No. PCT/JP2023/042137, filed on Nov. 24, 2023.

(30) Foreign Application Priority Data
Nov. 28, 2022 (JP) 2022-188904

(51) Int. Cl. H04N 1/00

(52) U.S. Cl. CPC H04N 1/00005; H04N 1/0001; H04N 1/00023; H04N 1/00034; H04N 1/00082

(57) ABSTRACT

A quality inspection apparatus capable of communicating with at least an image forming apparatus includes a first reception unit that receives from the image forming apparatus a first image generated by execution of image generation processing on print data by the image forming apparatus from the image forming apparatus, a first inspection unit that performs first inspection based on a scanned image acquired by reading of a printed product printed by the image forming apparatus and the first image, a second inspection unit that performs second inspection based on a second image generated by execution of image generation processing on the print data by an image processing apparatus and the first image, and a transmission unit that transmits information based on a result of inspection performed by the first inspection unit and a result of inspection performed by the second inspection unit to the image forming apparatus.

### CROSS-REFERENCE TO RELATED APPLICATIONS

This application is a Continuation of International Patent Application No. PCT/JP2023/042137, filed Nov. 24, 2023, which claims the benefit of Japanese Patent Application No. 2022-188904, filed Nov. 28, 2022, both of which are hereby incorporated by reference herein in their entirety.

### BACKGROUND OF THE INVENTION

### Field of the Invention

The present invention relates to a quality inspection apparatus and an inspection system.

### Background Art

A digital print technique based on electrophotography or the like, which is called print-on-demand, has become common mainly in the print industry, and there is a need for maintaining print quality and effectively producing printed products. To maintain print quality, a quality inspection apparatus that inspects image quality of printed products has been devised in late years.

According to Japanese Patent Application Laid-Open No. 2015-53561, when making determination, a quality inspection apparatus first registers image data generated by a raster image processor (RIP) in a print apparatus as a print sample image. The quality inspection apparatus uses image data, which is obtained by electronic reading of a medium on which image data has been printed, as an inspection target image, to determine whether the print sample image and the inspection target image are matched with each other, and checks whether there is no defect in a printed product.

A quality inspection apparatus that inspects image quality of a printed product performs image quality inspection based on image data generated by RIP processing that is appropriate for a print apparatus. Meanwhile, in industrial print, checking or the like of a document that is desired to be printed is performed based on a printed image subjected to RIP processing by a print apparatus that is used by a user in normal business operations or a RIP apparatus. The RIP apparatus has characteristics depending on each program included in the RIP apparatus and there may be a slight difference in color, image position, or the like.

### CITATION LIST

### Patent Literature

PTL 1: Japanese Patent Application Laid-Open No. 2015-53561

### SUMMARY OF THE INVENTION

According to an aspect of the present invention, a quality inspection apparatus capable of communicating with at least an image forming apparatus includes a reception interface (IF) configured to receive from the image forming apparatus a first image generated by execution of image generation processing on print data by the image forming apparatus, a controller having a processor which executes instructions stored in a memory or having circuitry, the controller being configured to execute first inspection based on a scanned image acquired by reading of a printed product printed by the image forming apparatus and the first image, and execute second inspection based on a second image generated by execution of image generation processing on the print data by an image processing apparatus and the first image, and a transmission IF configured to transmit information based on an inspection result of the first inspection and an inspection result of the second inspection to the image forming apparatus.

Further features of the present invention will become apparent from the following description of exemplary embodiments with reference to the attached drawings.

### BRIEF DESCRIPTION OF THE DRAWINGS

FIG. 1 is an example of a schematic diagram illustrating an overall configuration for describing an exemplary embodiment.

FIG. 2 is an example of a diagram illustrating a print apparatus and a quality inspection apparatus for describing the exemplary embodiment.

FIG. 3 is an example of a schematic diagram illustrating an overall hardware configuration for describing the exemplary embodiment.

FIG. 4A is an example of a diagram illustrating each program for describing the exemplary embodiment.

FIG. 4B is an example of a diagram illustrating each program for describing the exemplary embodiment.

FIG. 4C is an example of a diagram illustrating each program for describing the exemplary embodiment.

FIG. 4D is an example of a diagram illustrating each program for describing the exemplary embodiment.

FIG. 4E is an example of a diagram illustrating each program for describing the exemplary embodiment.

FIG. 5 is an example of a sequence chart for describing registration of a print sample image according to a first exemplary embodiment.

FIG. 6 is an example of a sequence chart for describing inspection according to the first exemplary embodiment.

FIG. 7 illustrates an example of a screen for registering a print sample image according to the first exemplary embodiment.

FIG. 8A illustrates an example of a screen for making inspection settings according to the first exemplary embodiment.

FIG. 8B illustrates an example of a screen for making inspection settings according to the first exemplary embodiment.

FIG. 9A illustrates an example of a screen for displaying an inspection result according to the first exemplary embodiment.

FIG. 9B illustrates an example of a screen for displaying an inspection result according to the first exemplary embodiment.

FIG. 9C illustrates an example of a screen for displaying an inspection result according to the first exemplary embodiment.

FIG. 10 is a flowchart for describing step S2007.

FIG. 11 is a flowchart for describing step S3002.

FIG. 12 is a flowchart for describing step S3003.

FIG. 13 is a flowchart for describing step S2010.

FIG. 14 is an example of a sequence chart for describing a second exemplary embodiment.

FIG. 15 is an example of a flowchart for describing a third exemplary embodiment.

### DESCRIPTION OF THE EMBODIMENTS

A print quality inspection apparatus performs print inspection by comparing a sample image created by raster image processor (RIP) processing in a print apparatus and a printed image subjected to RIP processing in the print apparatus, and is thereby capable of inspecting scratches, smudges, and the like on a printed product. Meanwhile, the print quality inspection apparatus is not capable of performing inspection in reflection of a difference in characteristics between RIP processing performed in the print apparatus and RIP processing performed in a print apparatus that is used by a user in normal business operations or a RIP apparatus. Thus, the print quality inspection apparatus has determined that a result is OK even if a deliverable is different in color or shifted in an image position from a printed product as expected by the user, that is, a printed product subjected to RIP processing.

One object of the present invention is to perform print inspection on a printed material as expected by the user. Another object of the present invention is to output an inspection result in consideration of a difference between image data generated by RIP processing in the RIP apparatus and image data generated by RIP processing in the print apparatus.

A best mode for implementing the present invention will be described below with reference to drawings.

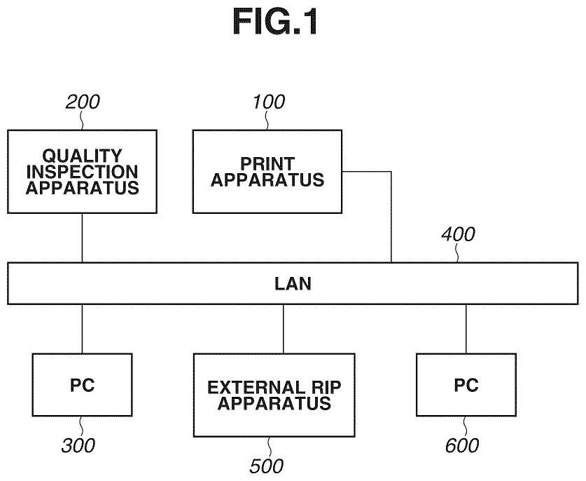

FIG. 1 is a diagram illustrating an overall configuration of an image inspection system (printed product inspection system) for describing an exemplary embodiment. In the following description, a print apparatus may also be referred to as an image forming apparatus, a multi-function apparatus or a multi-function peripheral (MFP). Additionally, an external RIP apparatus according to the present exemplary embodiment represents an apparatus that performs RIP processing that is different from RIP processing performed by a print apparatus 100, and may be also referred to as an image processing apparatus or a RIP apparatus. Although it is called the external RIP apparatus, the external RIP apparatus is not necessarily an apparatus that performs only RIP processing and may be a print apparatus that performs RIP processing and then executes print.

A personal computer (PC) 300 and a PC 600 are connected to the print apparatus 100 by a local area network (LAN) 400. Furthermore, a quality inspection apparatus 200 is connected to the LAN 400. The print apparatus 100 and the quality inspection apparatus 200 are connected to each other so that a medium can be directly conveyed therebetween. The print apparatus 100 and the quality inspection apparatus 200 may also be collectively referred to as a print quality inspection apparatus. Furthermore, an external RIP apparatus 500 is connected to the LAN 400.

The external RIP apparatus 500 may be a RIP apparatus that is used by a user who uses the image inspection system at the time of offset print or a RIP apparatus that is used for proof print. However, the external RIP apparatus 500 is the one that is capable of converting print data such as page description language (PDL) data or portable document format (PDF) data into image data as expected by the user.

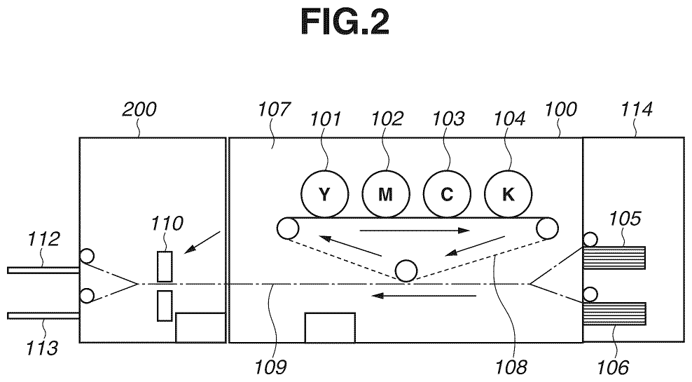

FIG. 2 is a diagram illustrating a detailed configuration regarding the print apparatus 100 and the quality inspection apparatus 200. Image forming stations 101 to 104 are used to perform color print in yellow, magenta, cyan, and black, respectively. As the image forming stations 101 to 104, it is conceivable to employ an image forming means using electrophotography, an inkjet method, or the like, but the present invention is not limited thereto. Additionally, the present invention can be implemented by a configuration of performing monochrome print, for example, a configuration including only the image forming station 104 for black.

A paper feeding device 114 is configured to include a paper feeding deck, and is capable of feeding a recording sheet such as paper from a paper feeding unit 105 or 106 to perform print on the recording sheet.

An intermediate transfer belt 108 rotates, and color materials are transferred to the intermediate transfer belt 108 from the image forming stations 101 to 104. Furthermore, the color materials are transferred in a contact portion with a medium conveyed on a paper conveying path 109 toward the downstream side.

The paper conveying path 109 is connected to the print apparatus 100 and the quality inspection apparatus 200, and the printed medium is directly conveyed to the inside of the quality inspection apparatus 200.

A pair of image sensors 110 is installed with the paper conveying path 109 interposed therebetween, and captures images of both sides of the medium on the paper conveying path 109. The images captured by the image sensors 110 are used for registration of a print sample image or execution of inspection. A plurality of paper discharge units is installed, and a printed product is sorted into paper discharge units 112 and 113 based on an inspection result. For example, a printed product whose inspection result is determined as OK is discharged to the paper discharge unit 112, and a printed product whose inspection result is determined as a fail is discharged to the paper discharge unit 113 for purging.

In the present exemplary embodiment, the description is being given of the case where the quality inspection apparatus 200 controls a paper discharge destination of a printed product based on an inspection result, but the configuration is not limited thereto. For example, the image inspection system may employ a configuration in which a quality inspection apparatus makes notification about an inspection result and a print apparatus including a paper discharge unit controls a paper discharge destination of a printed product based on the inspection result.

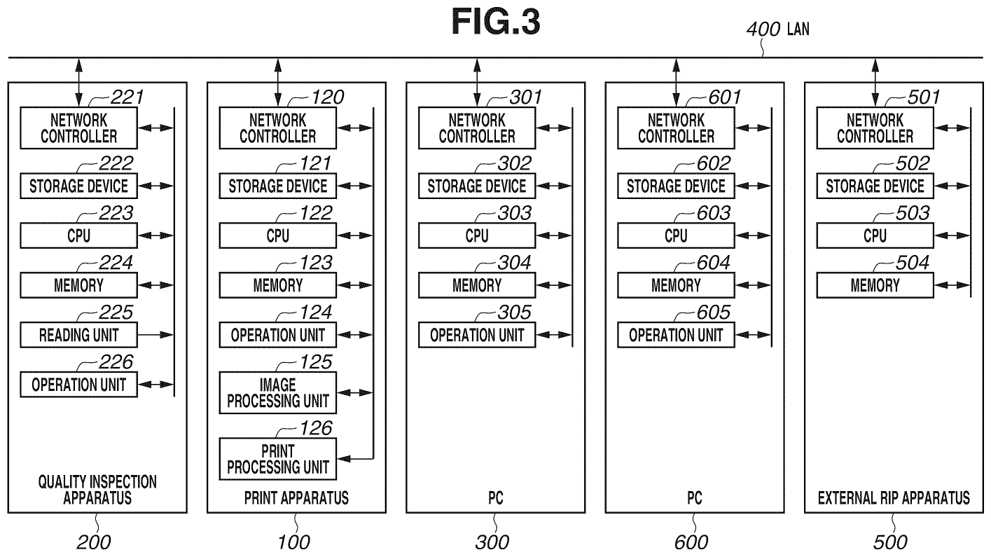

FIG. 3 illustrates a circuit configuration of each apparatus.

The print apparatus 100 is connected to the LAN 400 via a network controller 120. Additionally, processing executed by the print apparatus 100 is implemented by a central processing unit (CPU) 122 loading a program, which is stored in a storage device 121, in a memory 123 and executing the program. The print apparatus 100 includes an operation unit 124 and is capable of performing display on a screen to accept an input operation from the outside. The print apparatus 100 further includes an image processing unit 125. The image processing unit 125 converts electronic image data (for example, multi-value image data of Commission Internationale de L′Eclairage (CIE)-standard red, green, and blue (sRGB) into electronic image data for print (for example, a cyan (C), magenta (M), yellow (Y), and black (K) halftone image). Furthermore, the electronic image data for print is transferred to a print processing unit 126, and the print apparatus 100 uses the image forming stations 101 to 104 to transfer the electronic image data for print to recording paper fed from the paper feeding device 114 and performs print.

The quality inspection apparatus 200 is connected to the LAN 400 via a network controller 221. Additionally, processing executed by the quality inspection apparatus 200 is implemented by a CPU 223 loading a program, which is stored in a storage device 222, in a memory 224 and executing the program. Furthermore, the quality inspection apparatus 200 uses a reading unit 225 connected to the image sensors 110 to convert an image on the recording paper conveyed through the paper conveying path 109 into electronic image data (for example, R, G, and B multi-value image data). An operation unit 226 functions as a display unit that displays a print sample, which will be described below, and an inspection setting screen, and also accepts input from a user. Screens displayed on the display unit are controlled by the CPU 223, and the CPU 223 may be referred to as a display control unit in the present exemplary embodiment.

The PC 300 for giving an instruction for print to the print apparatus 100 is connected to the LAN 400 via a network controller 301. Additionally, processing executed by the PC 300 is implemented by a CPU 303 loading a program, which is stored in a storage device 302, in a memory 304 and executing the program. Furthermore, an operation unit 305 is connected to a display (not illustrated), and allows for screen display. Furthermore, the operation unit 305 is connected to a mouse and a keyboard (not illustrated), and allows for an operation of a program.

The PC 600 to be used solely for RIP inspection is connected to the LAN 400 via a network controller 601. Additionally, processing executed by the PC 600 is implemented by a CPU 603 loading a program, which is stored in a storage device 602, in a memory 604 and executing the program. Furthermore, an operation unit 605 is connected to a display (not illustrated), and allows for screen display. Furthermore, the operation unit 605 is connected to a mouse and a keyboard (not illustrated), and allows for an operation of a program. The PC 600 will be used in description of a second exemplary embodiment.

The external RIP apparatus 500 is connected to the LAN 400 via a network controller 501. Additionally, processing executed by the external RIP apparatus 500 is implemented by a CPU 503 loading a program, which is stored in a storage device 502, in a memory 504 and executing the program.

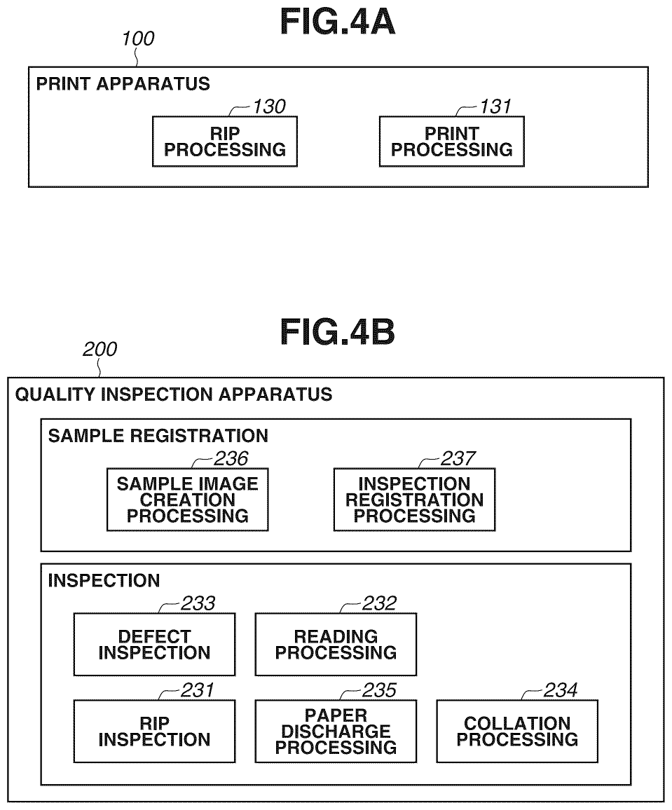

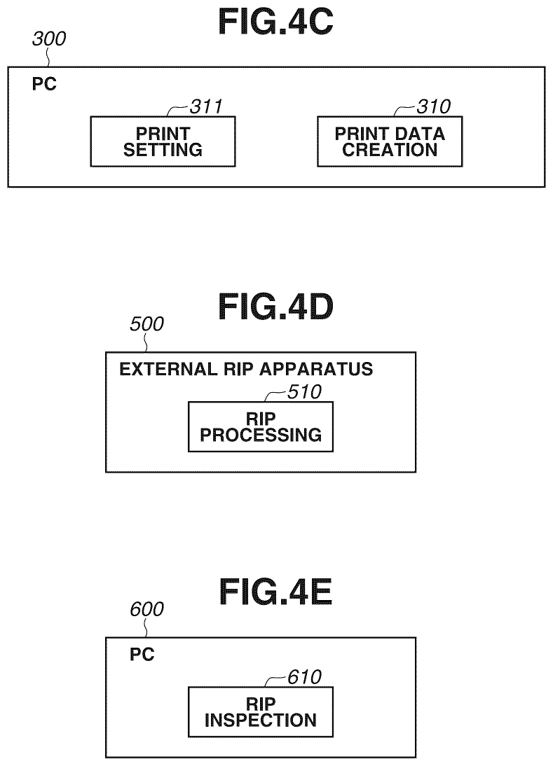

FIGS. 4A to 4D illustrate programs stored in the storage devices 121, 222, 302, 502, and 602, respectively. FIG. 4A illustrates programs stored in the print apparatus 100. Similarly, FIG. 4B illustrates programs stored in the quality inspection apparatus 200, FIG. 4C illustrates programs stored in the PC 300, FIG. 4D illustrates a program stored in the external RIP apparatus 500, and FIG. 4E illustrates a program stored in the PC 600. Details of the programs illustrated in FIGS. 4A to 4E will be described below.

While the quality inspection apparatus 200 is provided with the operation unit 226, it is assumed that the CPU 223 has a function of generating a Hypertext Markup Language (HTML) for a screen. Thus, it is possible to perform display on the operation unit 305 in the PC 300 and operate the operation unit 305 using a Hypertext Transfer Protocol (HTTP). Hence, in the present invention, an apparatus that performs display and accepts an operation is not specifically limited.

### First Exemplary Embodiment

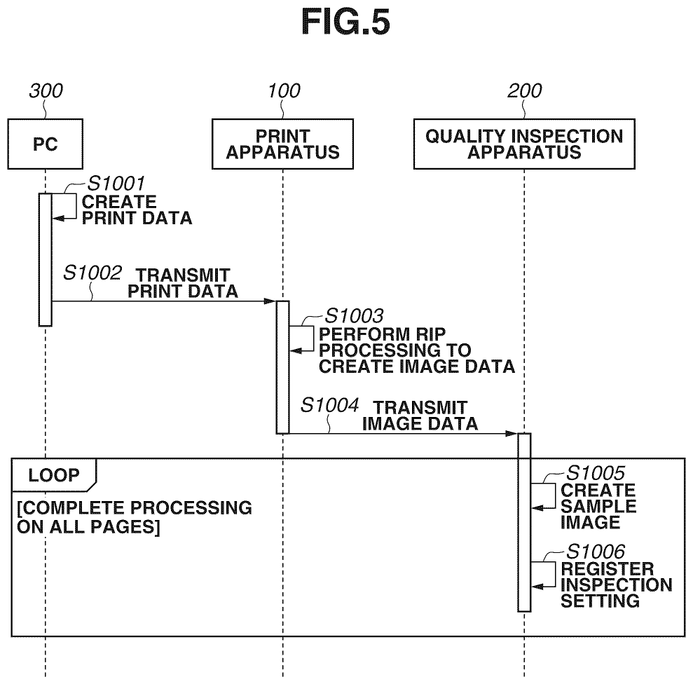

A first exemplary embodiment is now described with reference to a sequence chart in FIG. 5. In the print apparatus 100, the quality inspection apparatus 200, the PC 300, and the external RIP apparatus 500, processing is implemented by loading of each program, which is stored in a corresponding one of the storage devices 121, 222, 302, and 502, in a corresponding RAM and execution of the program by a corresponding one of the CPUs 122, 223, 303, and 503. Additionally, when transmitting or receiving data such as an image or a command, the print apparatus 100, the quality inspection apparatus 200, the PC 300, and the external RIP apparatus 500 respectively use the network controllers 120, 221, 301, and 501 to access the data or the command and store and read out the data or the command through the LAN 400. A description about a series of operations is omitted.

### <Registration of Print Sample>

First, a method of registering a print sample for inspection is described with reference to the sequence chart in FIG. 5.

In step S1001, when accepting an instruction for print from the operation unit 305, the CPU 303 in the PC 300 executes a print data creation program 310 and creates print data. The print data created here is composed of an image such as a Joint Photographic Experts Group (JPEG) image or a Tag Image File Format (TIFF) image, text data, font information to be used for the text data, graphics drawing data, and the like. Furthermore, the CPU 303 executes a print setting program 311, acquires print settings included in the accepted print instruction, and sets the print settings in the print data. The print settings include, for example, settings unique to the print apparatus 100 such as settings regarding from which paper feeding unit (the paper feeding unit 105 or 106) in the paper feeding device 114 paper is fed.

Subsequently, in step S1002, the CPU 303 in the PC 300 transmits the print data created in step S1001 to the print apparatus 100 via the LAN 400.

In step S1003, the CPU 122 in the print apparatus 100 executes a RIP processing program 130, performs RIP processing on received print data, and creates image data. The RIP processing mentioned herein is raster image processor processing, and represents processing of generating image data from received print data. Specifically, the RIP processing is to interpret a page description language (PDL), which is used in text data and image data, and convert the text data and the image data into a raster image. In the present exemplary embodiment, the RIP processing is referred to as image generation processing. The image data created here is electronic image data composed of color information such as C, M, Y, and K. In a case of print data in a plurality of pages, electronic image data for all the pages is created.

In step S1004, the CPU 122 in the print apparatus 100 transmits the image data created in step S1003 to the quality inspection apparatus 200 via the LAN 400.

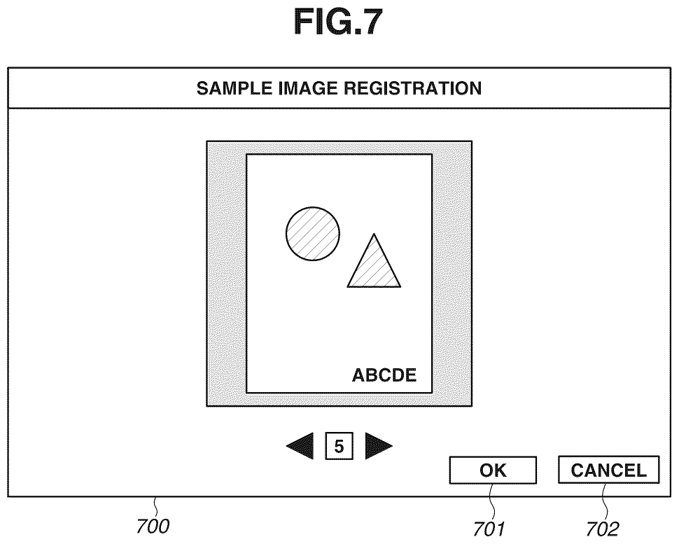

In step S1005, the CPU 223 in the quality inspection apparatus 200 executes sample image creation processing 236. Specifically, the CPU 223 creates a print sample image for image inspection based on the image data received in step S1004 and displays the print sample image on a screen 700. For example, in a case where the image data is a CMYK image, the CPU 223 performs color conversion processing using an International Color Consortium (ICC) profile preliminarily stored in the storage device 222 to convert the image data into RGB image data, and thereby creates the print sample image. FIG. 7 illustrates an example of the screen 700 for approving creation of the print sample image to be displayed on the operation unit 226. When the CPU 223 detects pressing of an OK button 701 from the operation unit 226, the processing proceeds to step S1006. In contrast, when detecting pressing of a cancel button 702 from the operation unit 226, the CPU 223 stops all processing, and ends creation of the print sample image.

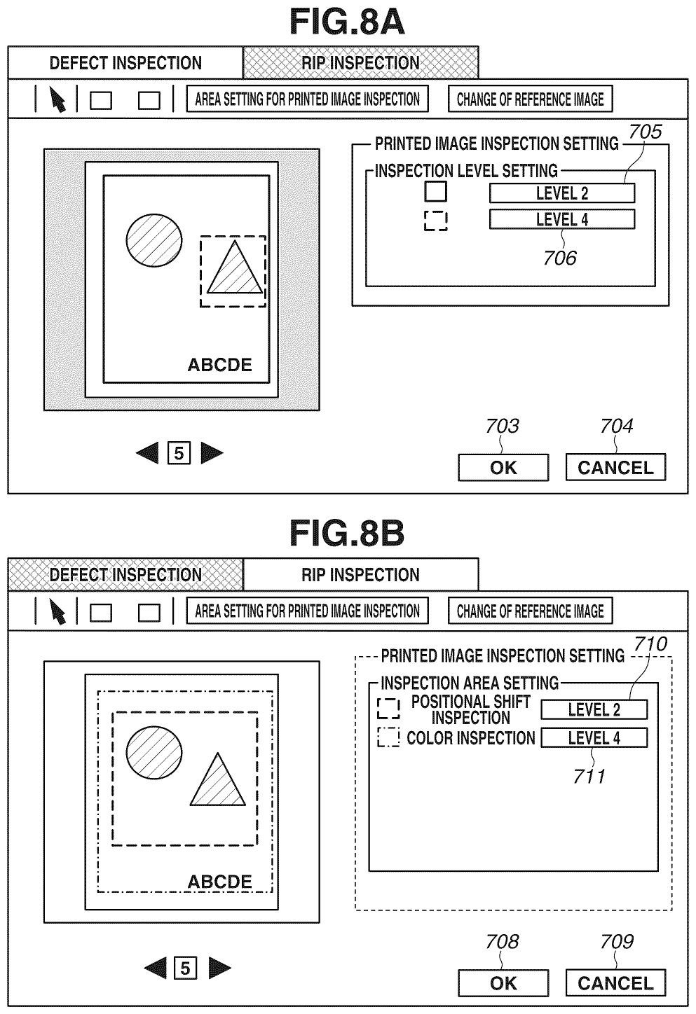

In step S1006, the CPU 223 in the quality inspection apparatus 200 executes inspection registration processing 237. Specifically, the CPU 223 registers an inspection setting accepted from an inspection setting screen illustrated in each of FIGS. 8A and 8B. On the inspection setting screen, the CPU 223 accepts the inspection setting while displaying the print sample image created in step S1005. FIGS. 8A and 8B each illustrate the inspection setting screen as an example. FIG. 8A illustrates an inspection setting screen for defect inspection. FIG. 8B illustrates an inspection setting screen for RIP inspection.

The defect inspection in FIG. 8A is to set a defect inspection level at the time of print. Examples of the defect at the time of print include, in a case of image formation in an electrophotographic process, toner smudges caused by insufficient cleaning in the image forming stations 101 to 104 or other factors. On the screen in FIG. 8A, it is possible to designate a freely-selected range on a displayed print sample image, and freely set image inspection level settings 705 and 706 in this range.

For example, if each of the image inspection level settings 705 and 706 is set at level 2, the CPU 223 determines that a result is OK even if there is a certain amount of smudges. In contrast, if each of the image inspection level settings 705 and 706 is set at level 4, it means a strict setting in which the CPU 223 determines that a result is a fail even with slight smudges.

Meanwhile, the RIP inspection in FIG. 8B represents a setting for inspecting whether the image data created by the RIP processing program 130 is correct image data. The RIP processing program is a program for interpreting the print data, and there are certain characteristics depending on a RIP processing program to be provided. For example, when text data is replaced by an image using a registered font and image data is created, there is a case where a font that is not included in a RIP processing program is replaced by a different font. Additionally, when a vector graphic pattern is drawn, a position of a drawn graphic pattern is different depending on characteristics of each RIP processing program. Furthermore, each RIP processing program has characteristics in interpretation of a layer structure, and there is a case where a color changes at the time of superimposition of drawn images. The screen in FIG. 8B is used to set a permissible level for a difference due to characteristics of each RIP processing program to be used. On the screen in FIG. 8B, it is possible to designate a freely-selected range on a displayed print sample image, and set an inspection level in a positional shift inspection setting 710 and an inspection level in a color inspection setting 711. The inspection level is a permissible level. A plurality of displayed inspection ranges in FIG. 8B allows for discrimination with a color of a displayed frame, a solid line, a ruled line, or the like. Additionally, the positional shift inspection and the color inspection can be performed in an identical region in an overlapping manner.

The screen illustrated in FIG. 8A and the screen illustrated in 8B can be switched by pressing of tabs in an upper stage.

When detecting pressing of an OK button 703 in FIG. 8A or an OK button 708 in FIG. 8B, the CPU 223 ends registration of the print sample image. At this time, the CPU 223 sets a name of inspection, and collectively stores the name of inspection together with the print sample image in the storage device 222 in the quality inspection apparatus 200 as a setting file.

### <Inspection>

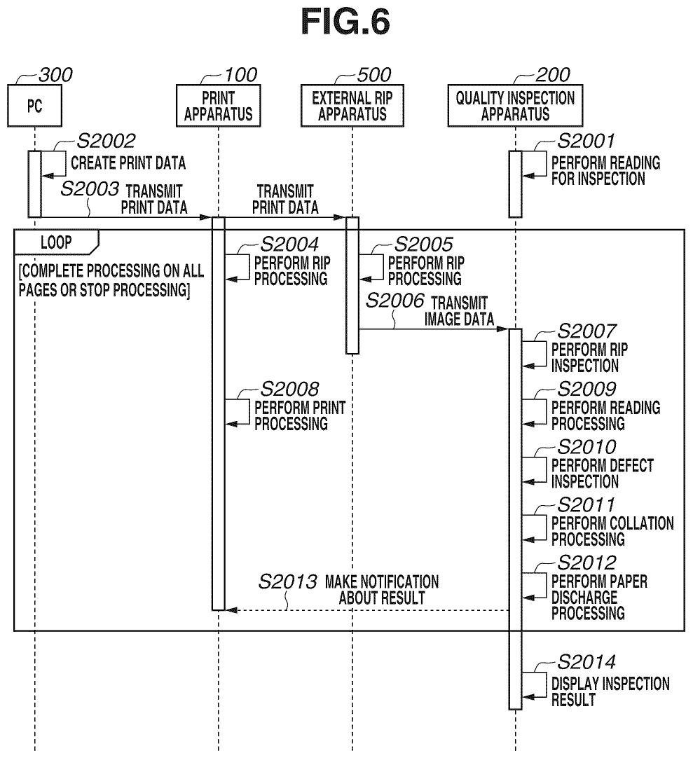

Subsequently, an inspection process is described with reference to FIG. 6.

In step S2001, when detecting the start of inspection, the CPU 223 in the quality inspection apparatus 200 reads out the print sample image and the setting file, which have been created in steps S1005 and S1006, from the storage device 222.

In step S2002, when accepting an instruction for print from the outside, the CPU 303 in the PC 300 executes the print data creation program 310 and creates print data. The present processing may be similar to the processing in step S1001. Step S2002 includes, in addition to the processing in step S1001, setting a number of copies, and allows for a print setting to print a plurality of copies.

In step S2003, the CPU 303 in the PC 300 transmits the print data created in step S1001 to the print apparatus 100 and the external RIP apparatus 500 via the LAN 400. In step S2004, the CPU 122 in the print apparatus 100 executes the RIP

processing program 130 and creates first image data. Specifically, the CPU 122 performs first RIP processing provided by the print apparatus 100 on the received print data, and creates first image data. In step S2005, the CPU 503 in the external RIP apparatus 500 executes a RIP processing program 510, creates second image data, and stores the second image data in the storage device 502. Specifically, the CPU 503 performs second RIP processing provided by the external RIP apparatus 500 on the received print data, and creates second image data.

In the present exemplary embodiment, the RIP processing program 130 and the RIP processing program 510 have an identical function, but are different programs. The RIP processing program 130 is designed solely for the print apparatus 100, and allows for generation of image data in which resolution necessary for the print apparatus 100 or the like is optimally set. In the present exemplary embodiment, the RIP processing program is a program that is built into the print apparatus 100, but may be a program built into another apparatus. Specifically, the image inspection system may have a separate RIP apparatus that performs RIP processing designed solely for the print apparatus 100, and the print apparatus 100 may receive image data created by the other RIP apparatus.

A description is now given of a reason that the print apparatus 100 does not execute print with image data subjected to RIP processing with use of the RIP processing program 510 provided by the external RIP apparatus 500. When creating image data from print data, the print apparatus 100 performs processing of making layout settings such as a media type and double-sided print. These layout settings are settings unique to the print apparatus 100, and generally cannot be processed by the RIP processing program 510. Hence, in a case where the print apparatus 100 executes print, it generally uses image data created with the RIP processing program 130.

Meanwhile, the RIP processing program 510 allows for generation of image data serving as a sample for print. For example, the RIP processing program 510 is considered to be a RIP processing program that has been used to create image data used for an operation of proofreading a document before a print operation.

In step S2006, the CPU 503 in the external RIP apparatus 500 transmits the image data created in step S2005 to the quality inspection apparatus 200 via the LAN 400. Alternatively, in step S2006, the CPU 223 in the quality inspection apparatus 200 may read the second image data stored in the storage device 302 via the LAN 400.

In step S2007, the CPU 223 in the quality inspection apparatus 200 executes a RIP inspection program 231. The CPU 223 uses the RIP inspection program 231 to compare pages on which print processing of the first image data and the second image data is being executed and check whether a result from the RIP processing program 130 is correct. The CPU 223 then outputs OK or a fail as a result of RIP processing. In a case where the result is a fail, the CPU 223 stores a defect image in the storage device 222. Details of RIP inspection will be described below. In the present exemplary embodiment, the CPU 223 performs RIP inspection once before reading processing in step S2009, but a timing is not limited thereto. The CPU 223 may be configured to perform RIP inspection once or multiple times at a timing at which defect inspection is performed.

In step S2008, the CPU 122 in the print apparatus 100 executes print processing 131. In the print processing 131, the CPU 122 reads out a created RIP image in a storage region in step S2004 and executes the print processing 131. In the print processing 131, after performing halftone processing on the RIP image in four colors (CMYK) and other processing, the CPU 122 places color materials on the intermediate transfer belt 108 in the image forming stations 101 to 104 and forms an image depending on the signal values. The formed image is transferred to recording paper, and conveyed immediately above/below the image sensors 110 for the front and back sides in the quality inspection apparatus 200 via the paper conveying path 109.

In step S2009, the CPU 223 in the quality inspection apparatus 200 executes reading processing 232, and reads the recording paper on which print has been performed in step S2008 with the image sensors 110 for the front and back sides. The CPU 223 converts the read data into scanned image data, and stores the scanned image data as third image data in the storage device 222.

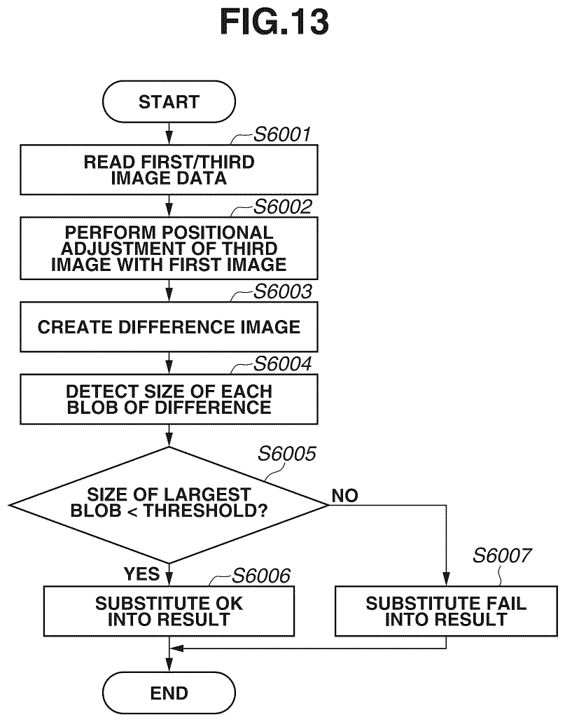

In step S2010, the CPU 223 in the quality inspection apparatus 200 executes defect inspection 233 on the first and third image data. In the defect inspection, the CPU 223 compares a sample image and a scanned image to inspect whether there are print smudges on a printed product. Details of a defect inspection method will be described below with reference to FIG. 13.

Since the third image data is data of an image obtained by reading of a medium printed by the print apparatus 100 with the image sensors 110, it is possible to detect a defect in the print apparatus 100. Details of the processing will be described below.

Image data created and used until step S2010 is summarized in Table 1. It is preferable that resolution of each image data be identical, and the present exemplary embodiment is based on the assumption that resolution is 300 dpi.

TABLE 1

| | | Apparatus that | Program |
|---|---|---|---|
| | Image type | creates image | to be used |
| First image | Print apparatus | Print | RIP inspection |
| data | RIP image | apparatus 100 | 231, defect |
| | | | inspection 233 |
| Second image | External RIP | RIP apparatus | RIP inspection |
| data | image | 500 | 231 |
| Third image | Print product read | Quality inspection | Defect inspection |
| data | image | apparatus 200 | 233 |

In step S2011, the CPU 223 in the quality inspection apparatus 200 executes collation processing 234 in response to the result in step S2009. In the collation processing, for example, the CPU 223 makes final determination according to the following Table 2, and controls an operation of each apparatus.

TABLE 2

| | Defect inspection = OK | Defect inspection = Fail |
|---|---|---|
| RIP inspection = | Normal paper | Purging discharge + |
| OK | discharge | re-print |
| RIP inspection = | Purging discharge + | Purging discharge + |
| Fail | stop | stop |

Normal paper discharge in Table 2 is processing of executing control of discharge of paper to the paper discharge unit 112 in the quality inspection apparatus 200. Additionally, purging paper discharge is processing of executing control of discharge of paper to the paper discharge unit 113 in the quality inspection apparatus 200. That is, the CPU 223 controls a paper discharge destination of a printed product as an inspection target depending on a result of inspecting the printed product, and can thereby sort printed products into a defective printed product that is determined as a fail in inspection and a printed product that is determined as OK in inspection. Combinations described in Table 2 may be preliminarily set as fixed values, or settings made by a system administrator may be accepted.

Even in a case where a result of the defect inspection is OK but if a result of the RIP inspection is a fail, the CPU 223 determines that the printed product is not appropriate as a deliverable, performs purging discharge, and stops print. The CPU 223 performs purging discharge because there is no smudge on the printed product, but the printed product is different in print position and/or color from a deliverable desired by the user. Furthermore, since there is an error in the RIP processing in the print apparatus 100, the CPU 223 also stops print itself.

Additionally, in a case where a result of the defect inspection is a fail but if a result of the RIP inspection is OK, the CPU 223 performs purging discharge and re-print processing. The CPU 223 performs purging discharge because an image is appropriate as the deliverable desired by the user, but there are smudges on the printed product. However, since there is no error in the RIP processing itself, the CPU 223 performs re-print processing. The purging discharge mentioned herein represents discharge of the print product to a tray for a print product determined as a fail, which is different from a tray for a print product determined as OK, but is not limited thereto. In the purging discharge, the CPU 223 performs discharge so as to discriminate between a print product determined as OK in inspection and a print product determined as a fail in inspection.

In step S2012, the CPU 223 in the quality inspection apparatus 200 executes paper discharge processing 235 according to Table 2. In step S2013, after the completion of the processing in step S2012, the CPU 223 transmits the result to the print apparatus 100. In a case of re-print according to Table 2, the CPU 223 re-executes processing in step S2008 to perform re-print of an identical page. In this case, the CPU 223 in the quality inspection apparatus 200 re-executes processing steps S2009 to S2012.

The CPU 223 repeatedly executes processing steps S2004 to S2013 until it completes print and inspection of all pages in the set number of copies. Additionally, in a case of determining to stop print in step S2011, the CPU 223 ends repetition processing. The processing then proceeds to step S2014.

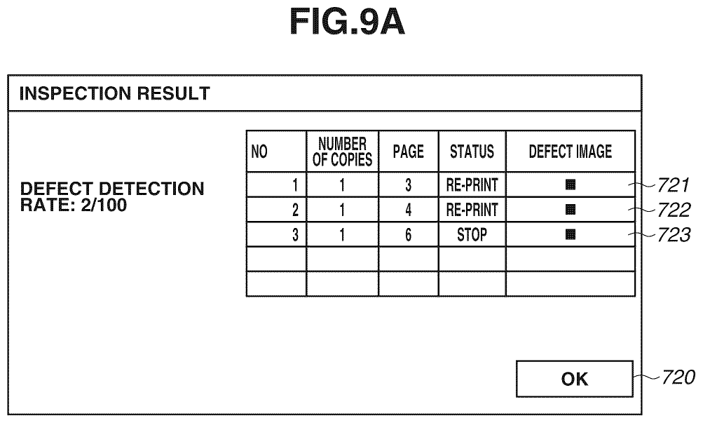

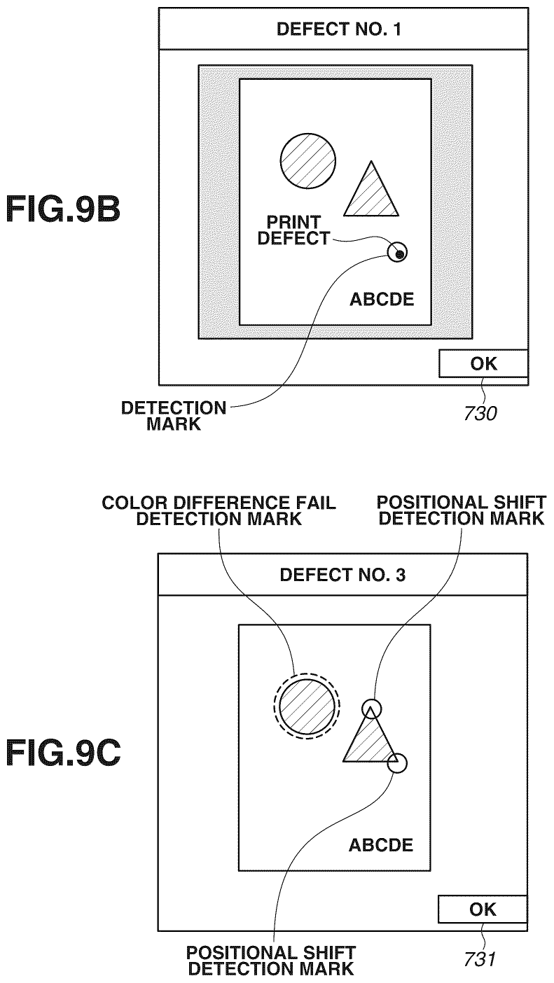

In step S2014, the CPU 223 displays an inspection result. FIG. 9A displays an example of display of a result. When detecting pressing of an OK button 720, the CPU 223 ends inspection.

Additionally, in FIG. 9A, buttons 721, 722, and 723 for displaying detected defect images are disposed. When detecting pressing of the button 721, the CPU 223 displays a screen illustrated in FIG. 9B. The screen illustrated in FIG. 9B displays a defect at the time of print with use of the third image data. When detecting pressing of the button 723, the CPU 223 displays a screen illustrated in FIG. 9C. The screen illustrated in FIG. 9C displays detection of a positional shift and/or detection of a fail regarding a color difference at the time of the RIP inspection with use of the first image data or the second image data.

In a case where there are both the defect at the time of print and detection of the positional shift and/or the fail regarding the color difference at the time of the RIP inspection, two buttons for displaying detected defect images may be prepared. In this case, prepared are a screen that displays the defect at the time of print with use of the third image data and a screen that displays detection of the positional shift and/or the fail regarding the color difference at the time of the RIP inspection with use of the first image data or the second image data. Additionally, the screen that displays the defect at the time of print with use of the third image data and the screen that displays detection of the positional shift and/or the fail regarding the color difference at the time of the RIP inspection with use of the first image data or the second image data may be displayed side by side on one screen. Alternatively, an image that merges the screen that displays the defect at the time of print with use of the third image data and the screen that displays detection of the positional shift and/or the fail regarding the color difference at the time of the RIP inspection with use of the first image data or the second image data may be created. In this case, the defect in print and the fail regarding the color difference and/or the positional shift may be superimposed on the merged image.

### <RIP Inspection>

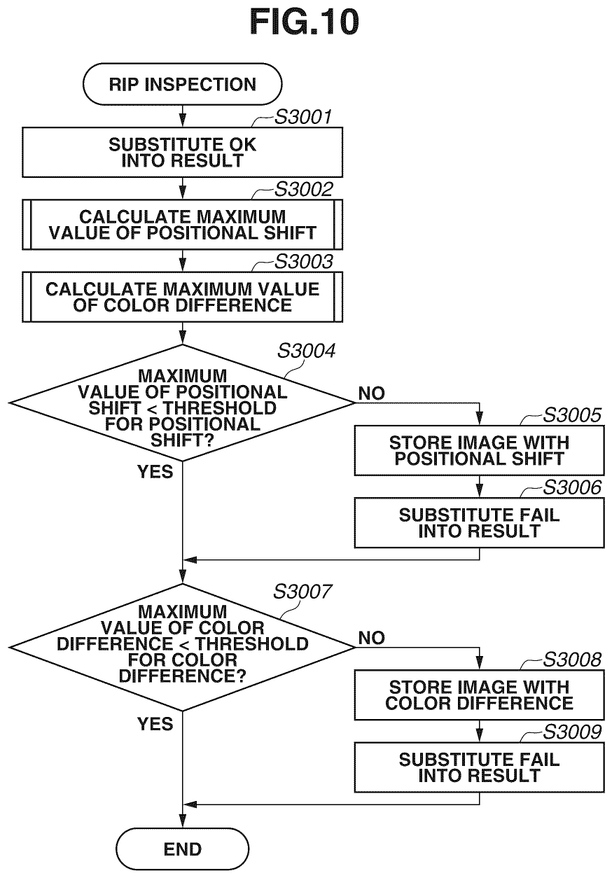

The RIP inspection program 231 executed by the CPU 223 in the quality inspection apparatus 200 in step S2007 is now described with reference to FIG. 10.

In step S3001, the CPU 223 first substitutes “inspection: OK” into a result as an initial value. In step S3002, the CPU 223 calculates a maximum value of a positional shift between the first and second image data. Regarding the positional shift, the CPU 223 calculates feature points in the first and second image data and compares respective positions. A method of calculating the maximum value of the positional shift will be described below.

In step S3003, the CPU 223 calculates a maximum value of a color difference between the first and second image data. A method of calculating the maximum value of the color difference will be described below.

In step S3004, the CPU 223 compares the maximum value of the positional shift calculated in step S3002 and a threshold according to a positional shift inspection level set in step S1006. The threshold is stored in the storage device 222, and is based on, for example, Table 3. Additionally, the positional shift inspection level is set by an administrator of the quality inspection apparatus 200. Since the positional shift inspection level is set at level 2 in the screen example illustrated in FIG. 8B, a positional shift up to 1 mm is permitted.

TABLE 3

| Permissible level for positional shift | Threshold for positional shift (mm) |
|---|---|
| Level 1 | 2 |
| Level 2 | 1 |
| * Level 3 | 0.5 |
| Level 4 | 0.1 |

* Default setting

As a result of comparison, if the positional shift is smaller than the threshold (YES in step S3004), the processing proceeds to step S3007. In contrast, if the positional shift is larger than the threshold (NO in step S3004), the processing proceeds to step S3005.

In step S3005, the CPU 223 stores, in the storage device 222, an image created in step S3002 and showing feature points indicating the positional shift. In step S3006, the CPU 223 substitutes “inspection: fail” into a result.

In step S3007, the CPU 223 compares the maximum value of the color difference calculated in step S3003 and a threshold based on a value determined according to a color difference inspection level set in step S1006. The color difference is calculated by conversion into CIE-L*a*b*. The CPU 223 reads out an ICC profile for converting CMYK image data into an image in the CIE-L*a*b* space from the storage device 222 and performs color space conversion. The CPU 223 calculates the color difference by obtaining a Euclidean distance in the CIE-L*a*b* space, which will be described below. The threshold is stored in the storage device 222, and is based on, for example, Table 4. Additionally, the color difference inspection level is set by the administrator of the quality inspection apparatus 200. Since the color difference inspection level is set at level 2 in the screen example illustrated in FIG. 8B, ΔE of up to 4 is permitted.

TABLE 4

| Permissible level color difference | Threshold for color difference (ΔE) |
|---|---|
| Level 1 | 6 |
| Level 2 | 4 |
| * Level 3 | 3 |
| Level 4 | 0 |

* Default setting

As a result of comparison, if the color difference is smaller than the threshold (YES in step S3007), the flow of the RIP inspection ends. In contrast, if the color difference is larger than the threshold (NO in step S3007), the processing proceeds to step S3008.

In step S3008, the CPU 223 stores, in the storage device 222, an image created in step S3003 and marking a region that is determined as a fail regarding the color difference. In step S3009, the CPU 223 substitutes “inspection: fail” into a result.

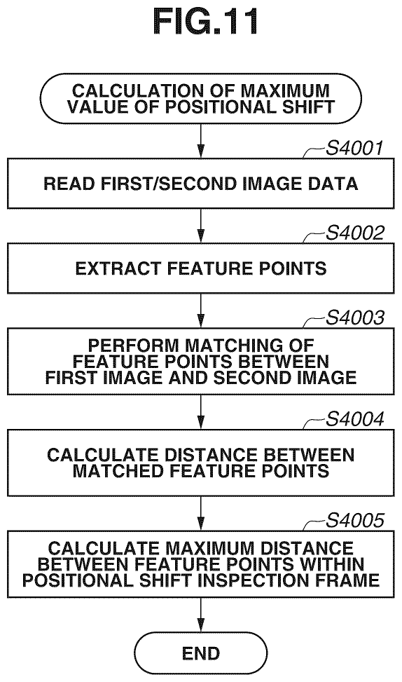

Subsequently, the method of calculating the maximum value of the positional shift in step S3002 is now described with reference to a flowchart in FIG. 11.

In step S4001, the CPU 223 reads out the first and second image data from the storage device 222. In step S4002, the CPU 223 uses a feature quantity extraction method such as a scale invariant feature transform (SIFT) to extract feature points from the read first and second image data and acquires coordinates of the feature points.

In step S4003, the CPU 223 obtains coordinates of corresponding second feature points from the coordinates of the feature points extracted in step S4002 from the first image data, and performs matching with use of a method such as Fast Library for Approximate Nearest Neighbors (FLANN). However, it is sufficient if the CPU 223 calculates only feature points at coordinates in a positional shift inspection frame illustrated in FIG. 8B.

In step S4004, the CPU 223 calculates a Euclidean distance between feature points matched in step S4003 between the first and second image data. In step S4005, the CPU 223 obtains feature points whose Euclidean distance becomes a maximum distance among the feature points calculated in step S4004, and stores the feature points in the storage device 222.

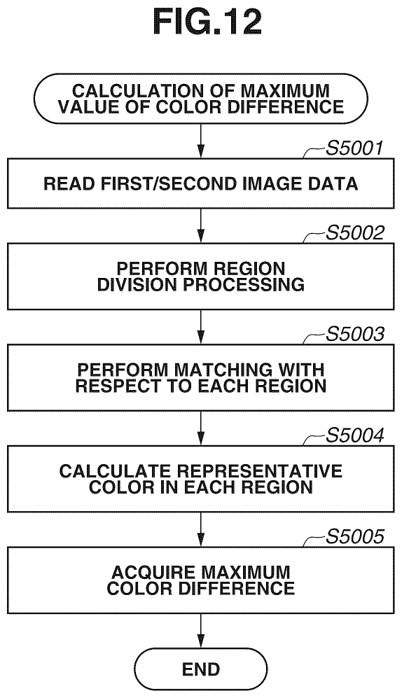

Subsequently, the method of calculating the maximum value of the color difference in step S3003 is described with reference to a flowchart in FIG. 12.

In step S5001, the CPU 223 reads out the first and second image data from the storage device 222. In step S5002, the CPU 223 uses an algorithm such as a mean shift method with respect to the first and second image data to perform region division processing.

In step S5003, the CPU 223 performs matching of regions between the first and second image data. With this processing, determined is whether a division region created in step S5002 in the first image data corresponds to a division region created in step S5002 in the second image data. As a means of determination, the CPU 223 calculates a centroid of each region in the first and second image data to determine representative coordinates, and can determine regions close to the representative coordinates as corresponding regions.

In step S5004, the CPU 223 determines a representative color in the division region created in step S5002. The representative color is determined by calculation of an average of CMYK density values of pixels constituting each region and conversion into CIE-L*a*b*. In step S5005, the CPU 223 obtains a color difference in the CIE-L*a*b* space between corresponding regions obtained in step S5003 in the first and second image data with respect to the representative color calculated in step S5004 in each region, and stores a maximum color difference among obtained color differences in the storage device 222.

The CPU 223 executes the RIP inspection in step S2007 with use of the above-mentioned processing.

### <Defect Inspection>

The defect inspection executed by the CPU 223 in step S2010 is described with reference to FIG. 13.

In step S6001, the CPU 223 reads out the first and third image data from the storage device 222. In step S6002, the CPU 223 performs positional adjustment processing so that a position of the third image data is matched with a position of the first image data. As a method of positional adjustment processing, it is possible to perform positional adjustment by detecting a position of an end portion of paper for the third image data and rotating the third image data using an affine transformation method or the like so that the position of the end portion of paper for the third image data is matched with an assumed end portion of an image in the first image data.

In step S6003, the CPU 223 performs subtraction between the first and third images subjected to positional adjustment in step S6002 and creates a difference image. Pixels remaining in this difference image can be determined as dusts or smudges that are supposed not to exist in an image.

In step S6004, the CPU 223 detects blobs from the difference image created in step S6003, and acquires a size of each blob. In the processing in step S6004, it is possible to make analysis using an image processing method called blob analysis.

In step S6005, the CPU 223 determines whether the largest blob among the blobs obtained in step S6004 is smaller than the level determined in step S1006. If the largest blob is smaller than the level determined in step S1006 (YES in step S6005), the processing proceeds to step S6006. In step S6006, the CPU 223 determines that a result of defect detection is OK. In contrast, if the largest blob is larger than the level determined in step S1006 (NO in step S6005), the CPU 223 determines that a result of defect detection is a fail. The threshold is stored in the storage device 222, and is based on, for example, Table 5. In Table 5, thresholds are defined based on the assumption of resolution of 300 dpi. Additionally, the inspection level is set by the administrator of the quality inspection apparatus 200.

TABLE 5

| Inspection level | Threshold for size of blob (pix) |
|---|---|
| Level 1 | 60 |
| Level 2 | 45 |
| * Level 3 | 25 |
| Level 4 | 15 |

* Default setting

As described above, the configuration of performing the RIP inspection and the defect inspection according to the first exemplary embodiment makes it possible to output a printed product without a defect as intended by the user and increase reliability of the print apparatus 100.

In the present exemplary embodiment, the description has been given of the method in which one quality inspection apparatus 200 performs the RIP inspection and the defect inspection, but the number of quality inspection apparatuses 200 is not limited to one. For example, the image inspection system may employ a configuration in which two quality inspection apparatuses 200 are communicably connected to each other, the first quality inspection apparatus 200 performs the RIP inspection, and the second quality inspection apparatus 200 performs the defect inspection.

Additionally, in the present exemplary embodiment, the description has been given based on the assumption that the quality inspection apparatus 200 and the external RIP apparatus 500 are communicable via a network, but the quality inspection apparatus 200 and the external RIP apparatus 500 are not necessarily communicable. For example, the RIP processing in step S2005 in FIG. 6 may be preliminarily performed in the external RIP apparatus 500. Additionally, the external RIP apparatus 500 transmits image data to the quality inspection apparatus 200 in step S2006, but the image inspection system may have a configuration in which the quality inspection apparatus 200 receives image data subjected to RIP processing in the external RIP apparatus 500 using another method.

### Second Exemplary Embodiment

A description is now given of a second exemplary embodiment in which the registration of the print sample image in the first exemplary embodiment is automatically performed, and, furthermore, the RIP inspection is performed by the PC 600 instead of the quality inspection apparatus 200 to improve operability of the quality inspection apparatus 200 and reduce processing load of the quality inspection apparatus 200. A description of processing that is identical to that in the first exemplary embodiment is omitted as appropriate.

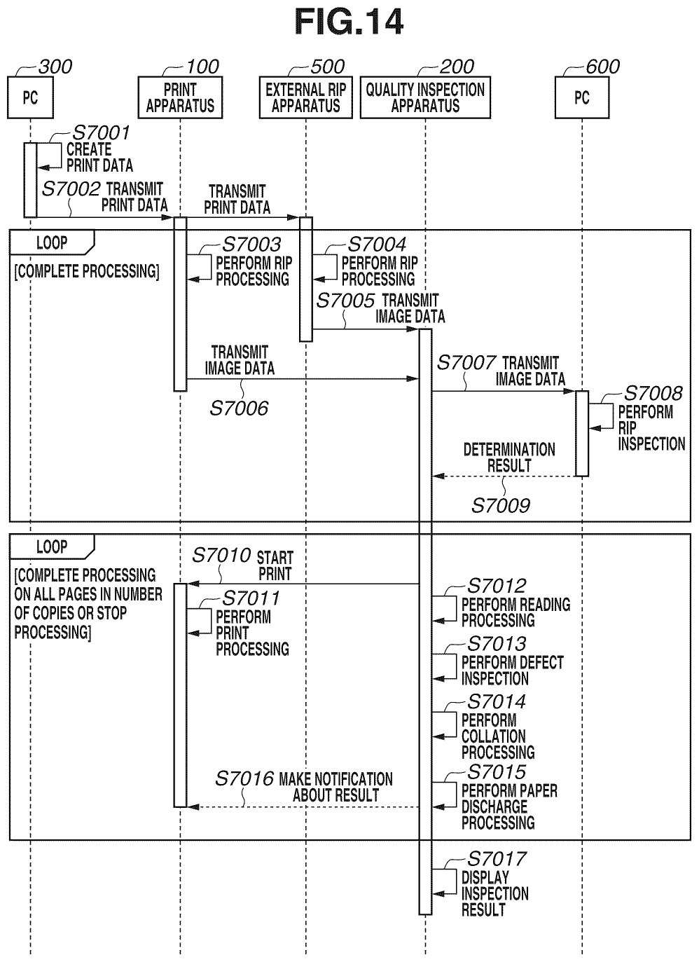

The second exemplary embodiment is described with reference to a sequence chart in FIG. 14.

### <Inspection>

In step S7001, when accepting an instruction for print from the outside or the operation unit 305, the CPU 303 in the PC 300 executes the print data creation program 310 and creates print data. Since this operation is identical to the operation in step S1001, and a detailed description thereof is omitted.

In step S7002, the CPU 303 in the PC 300 transmits the print data created in step S7001 to the print apparatus 100 and the external RIP apparatus 500 via the LAN 400.

Since step S7003 is identical to the processing in step S2004 and step S7004 is identical to the processing in step S2005, a detailed description thereof is omitted. Since step S7005 is identical to the processing in step S1004 and step S7006 is identical to the processing in step S2006, a detailed description thereof is omitted.

In step S7007, the CPU 223 in the quality inspection apparatus 200 transfers two pieces of image data received in steps S7005 and S7006 to the PC 600.

In step S7008, the CPU 603 in the PC 600 executes a RIP inspection program 610. Since processing with the RIP inspection program 610 is identical to the processing with the RIP inspection program 231, a detailed description thereof is omitted. However, in the second exemplary embodiment, the registration of the print sample image is not performed, and the settings in FIG. 8B are not individually made. Inspection is performed on the whole image with use of default settings in Tables 3 and 4.

In step S7009, the CPU 603 in the PC 600 transfers a result in step S7008 to the quality inspection apparatus 200.

The image inspection system performs processing in steps S7003 to S7009 on all the pages. In a case where a determination result in step S7009 is a fail, the image inspection system may stop the sequence in FIG. 14 and end processing.

In step S7010, the CPU 223 in the quality inspection apparatus 200 issues an instruction to start print to the print apparatus 100.

Since processing in steps S7011 to S7012 is identical to the processing in steps S2008 to S2009, a detailed description thereof is omitted.

Since processing in step S7013 is identical to the processing in step S2010, a detailed description thereof is omitted. However, in the second exemplary embodiment, the registration of the print sample image is not performed, and the settings in FIG. 8A are not individually made. The inspection is performed on the whole image with use of a default setting in Table 4.

Since processing in steps S7014 to S7017 is identical to the processing in steps S2011 to S2014, a detailed description thereof is omitted.

As described above, the configuration of performing the RIP inspection and the defect inspection according to the second exemplary embodiment makes it possible to output a printed product without a defect as intended by the user and increase reliability of the print apparatus 100.

### Third Exemplary Embodiment

In a third exemplary embodiment, a description is given of a method of using image data created by the external RIP apparatus 500 as a comparison image in the defect inspection 233 in the first exemplary embodiment.

### <Defect Inspection>

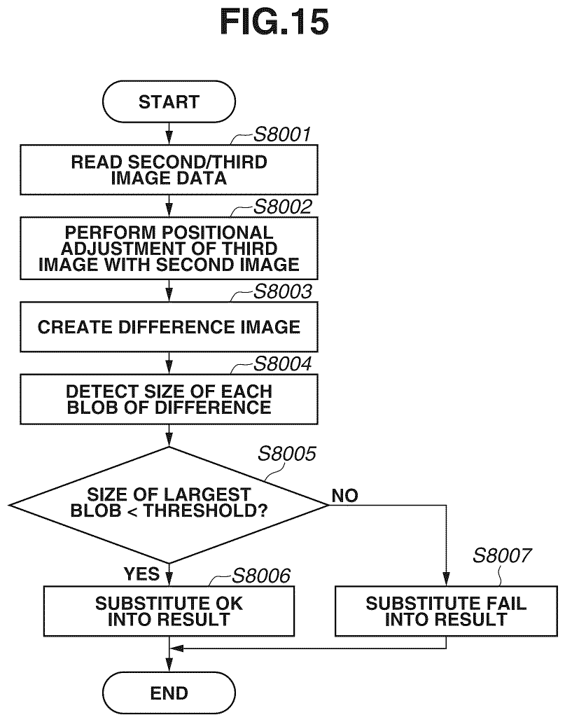

Defect inspection executed by the CPU 223 in step S2010 in a third exemplary embodiment will be described with reference to FIG. 15.

In step S8001, the CPU 223 reads the second and third image data from the storage device 222.

In step S8002, the CPU 223 performs positional adjustment processing so that a position of the third image data is matched with a position of the second image data. As a method of positional adjustment processing, it is possible to perform positional adjustment by detecting a position of an end portion of paper for the third image data and rotating the third image data using an affine transformation method or the like so that the position of the end portion of paper for the third image data is matched with an assumed end portion of an image in the second image data.

Since processing in steps S8003 to S8007 is identical to the processing in steps S6003 to S6007, a detailed description thereof is omitted.

As described above, the configuration of performing the RIP inspection and the defect inspection according to the third exemplary embodiment makes it possible to output a printed product without a defect as intended by the user and increase reliability of the print apparatus 100.

### Other Exemplary Embodiments

The description has been given above while various examples and various exemplary embodiments of the present invention are given, the gist and scope of the present invention are not limited to specific description in the present specification.

The present invention can also be implemented by supply of a program that implements one or more functions of the above-mentioned exemplary embodiments in a system or an apparatus via a network or a storage medium, and readout of the program and execution of processing of the program by one or more processors in a computer of the system or the apparatus. Furthermore, the present invention can also be implemented by a circuit (for example, an application-specific integrated circuit (ASIC)) that implements one or more functions.

The present invention is not limited to the above-mentioned exemplary embodiments, and can be changed and modified in various manners without departing from the spirit and range of the present invention. Thus, the claims are attached hereto to publicize the scope of the present invention.

### Other Embodiments

Embodiment(s) of the present invention can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

1. A quality inspection apparatus capable of communicating with at least an image forming apparatus, the quality inspection apparatus comprising:
a reception interface (IF) configured to receive from the image forming apparatus a first image generated by execution of image generation processing on print data by the image forming apparatus;
a controller having a processor which executes instructions stored in a memory or having circuitry, the controller being configured to:
execute first inspection based on a scanned image acquired by reading of a printed product printed by the image forming apparatus and the first image; and
execute second inspection based on a second image generated by execution of image generation processing on the print data by an image processing apparatus and the first image; and
a transmission IF configured to transmit information based on an inspection result of the first inspection and an inspection result of the second inspection to the image forming apparatus.

2. The quality inspection apparatus according to claim 1, wherein the controller is configured to compare the scanned image and the first image to inspect print smudges caused in print performed by the image forming apparatus.

3. The quality inspection apparatus according to claim 1, wherein the controller is configured to compare the first image and the second image to inspect a positional shift that is a difference between image data generated by execution of image generation processing by the image forming apparatus and image data generated by execution of image generation processing by the image processing apparatus.

4. The quality inspection apparatus according to claim 1, wherein the controller is configured to compare the first image and the second image to inspect a color difference that is a difference between image data generated by execution of image generation processing by the image forming apparatus and image data generated by execution of image generation processing by the image processing apparatus.

5. The quality inspection apparatus according to claim 1, further comprising a display,
wherein the second inspection is either positional shift inspection or color inspection or both the positional shift inspection and the color inspection, and
wherein, on a screen of the display on which the first image is displayed, both a range in which the positional shift inspection is executed and a range in which the color inspection is executed are designated or either the range in which the positional shift inspection is executed or the range in which the color inspection is executed is designated.

6. The quality inspection apparatus according to claim 5, wherein an inspection level is settable in a range in which the second inspection is executed.

7. The quality inspection apparatus according to claim 6, wherein the inspection level is a threshold for calculating an inspection result by comparison with a difference calculated from the first image and the second image.

8. The quality inspection apparatus according to claim 1, further comprising a display,
wherein the controller is configured to superimpose both a positional shift and a color difference that are detected by the second inspection or either the positional shift or the color difference that is detected by the second inspection on a screen of the display on which the first image is displayed.

9. The quality inspection apparatus according to claim 1, further comprising a display,
wherein the controller is configured to superimpose both a positional shift and a color difference that are detected by the second inspection or either the positional shift or the color difference that is detected by the second inspection on a screen of the display on which the second image is displayed.

10. The quality inspection apparatus according to claim 1,
wherein the quality inspection apparatus is communicably connected to the image processing apparatus, and
wherein the quality inspection apparatus further comprises another reception IF configured to receive the second image generated by execution of image generation processing on the print data by the image processing apparatus.

11. The quality inspection apparatus according to claim 1, wherein the information based on the inspection result of the first inspection and the inspection result of the second inspection is information to control a paper discharge destination of the printed product and information to control an operation of the image forming apparatus.

12. The quality inspection apparatus according to claim 11, wherein the information is information to stop print performed by the image forming apparatus in a case where the inspection result of the second inspection is a fail.

13. An inspection system in which at least an image forming apparatus, an image processing apparatus, and a quality inspection apparatus are communicably connected with one another, the inspection system comprising:
a registration unit configured to register a first image generated by execution of image generation processing on print data by the image forming apparatus;
a print unit configured to print the first image on a recording sheet;
a reading unit configured to read a printed product printed by the print unit and generate a scanned image;
a first inspection unit configured to compare the scanned image acquired by the reading unit and the first image registered by the registration unit;
a second inspection unit configured to compare a second image generated by execution of image generation processing on the print data by the image processing apparatus and the first image; and
a control unit configured to control a paper discharge destination of the printed product based on a result of the comparison made by the first inspection unit and a result of the comparison made by the second inspection unit.

14. The inspection system according to claim 13, wherein the first inspection unit is configured to compare the scanned image and the first image to inspect print smudges caused in print performed by the print unit.

15. The inspection system according to claim 13, wherein the second inspection unit is configured to compare the first image and the second image to inspect a positional shift and a color difference between image data generated by execution of image generation processing by the image forming apparatus and image data generated by execution of image generation processing by the image processing apparatus.

16. The inspection system according to claim 13, wherein, in a case where a result of inspection performed by the first inspection unit is OK, the control unit is configured to differentiate a paper discharge destination of the printed product depending on a result of inspection performed by the second inspection unit.

17. The inspection system according to claim 13, wherein, in a case where both a positional shift and a color difference are detected or either the positional shift or the color difference is detected as a result of the comparison made by the second inspection unit, the control unit is configured to perform control to stop print performed by the image forming apparatus.

18. The inspection system according to claim 13, wherein, in a case where a result of inspection performed by the first inspection unit is a fail and a result of inspection performed by the second inspection unit is OK, the control unit is configured to control the image forming apparatus to perform re-print.
